(19) United States
(12) Patent Application Publication
(10) Pub. No.: US 2026/0288396 A1
(43) Pub. Date: Sep. 24, 2026

(54) INDUSTRIAL PRINTING SYSTEM, MANAGEMENT SERVER, AND PROCESSING MANAGEMENT METHOD CAPABLE OF PROCESSING AT THE OPTIMAL PRINTING COST BY USING MACHINE LEARNING

(71) Applicant: KYOCERA Document Solutions Inc., Osaka (JP)

(72) Inventor: Taku MATSUO, Los Angeles, CA (US)

(73) Assignee: KYOCERA Document Solutions Inc., Osaka (JP)

(21) Appl. No.: 19/087,263

(22) Filed: Mar. 21, 2025

(51) Int. Cl. G06F 3/12

(52) U.S. Cl. CPC G06F 3/126; G06F 3/1205; G06F 3/1282

(57) ABSTRACT

Provided is an industrial printing system that processes jobs at optimal printing costs. The industrial printing system is provided with a component apparatus and a management server and performs production printing. DB stores characteristic data and processing result data of processed jobs, as well as processing performance data of component apparatuses. A learning unit learns a model that shows the relationship between the characteristics of jobs and processing results and performance of the component apparatus based on the characteristic data, processing result data, and processing performance data stored in the DB. The processing management unit outputs information on a job setting and a scheduling allocation for processing at optimal cost based on the model learned by the learning unit in accordance with the instruction information that includes the condition to be prioritized.

### BACKGROUND

The present disclosure relates to an industrial printing system, management server, and processing management method, particularly for industrial printing (production printing).

In industrial printing, also known as production printing, which uses commercial (industrial) printing equipment, the components of the final product are produced in separate processes. For example, in the case of bookbinding, the cover, main body (color), main body (black and white), promotional materials, bands, and shipping envelopes are each processed as a separate job. Then, while combining each job in the middle of the process, the final product is finished as a book.

In these production printing systems, multiple jobs that perform the same processing are managed collectively by a management server, and a large number of printing jobs are distributed and printed in an even manner.

As a typical technology, an industrial printing system that distributes production printing in a peer-to-peer manner is disclosed. This industrial printing system performs production printing and has a plurality of site servers. The plurality of site servers distribute and process printing jobs. Each site server is provided with a storage unit, a processing determination unit, and a processing management unit. The storage unit stores a capacity table indicating the capacity that can be processed in printing and post-processing. The processing determination unit determines, based on the capacity table stored in the storage unit, other site servers that can process the job from multiple site servers. The processing management unit sets a processing schedule for the job by the other site servers determined to be able to process it by the processing management unit, and it sends the job to the other site servers according to the schedule setting and requests processing.

### SUMMARY

An industrial printing system of the present disclosure is an industrial printing system that performs production printing having a component apparatus and a management server, including: a database that stores characteristic data and processing result data of processed jobs and the processing performance data of the component apparatus; a learning unit that learns a model that shows relationship between characteristics of the jobs and processing results and performances of the component apparatus based on the characteristic data, the processing result data, and the processing achievement data stored in the database; and a processing management unit that outputs information on a job setting and a scheduling allocation for processing at optimal cost based on the model learned by the learning unit in accordance with instruction information that includes condition to be prioritized.

A management server of the present disclosure is a management server that manages jobs of component apparatuses in an industrial printing system that performs production printing, including: a database that stores characteristic data and processing result data of processed jobs and the processing performance data of the component apparatus; a learning unit that learns a model that shows relationship between characteristics of the jobs and processing results and performances of the component apparatus based on the characteristic data, the processing result data, and the processing achievement data stored in the database; and a processing management unit that outputs information on a job setting and a scheduling allocation for processing at optimal cost based on the model learned by the learning unit in accordance with instruction information that includes condition to be prioritized.

A processing management method of the present disclosure is a processing management method executed by a management server that manages jobs of component apparatuses in an industrial printing system that performs production printing, including the steps of: storing characteristic data and processing result data of processed jobs and the processing performance data of the component apparatus; learning a model that shows relationship between characteristics of the jobs and processing results and performances of the component apparatus based on the characteristic data, the processing result data, and the processing achievement data that are stored; and outputting information on a job setting and a scheduling allocation for processing at optimal cost based on the learned model in accordance with instruction information that includes condition to be prioritized.

### BRIEF DESCRIPTION OF THE DRAWINGS

FIG. 1 is an example of a system configuration diagram of an industrial printing system according to an embodiment of the present disclosure;

FIG. 2 is a block diagram showing the control configuration of the management server as shown in FIG. 1;

FIG. 3 is a block diagram showing the functional configuration of the management server as shown in FIG. 1;

FIG. 4 is a block diagram showing details of the processing DB as shown in FIG. 3;

FIG. 5 is a block diagram showing details of the job as shown in FIG. 3;

FIG. 6 is a flowchart of the job order process according to the embodiment of the present disclosure; and

FIG. 7 is a conceptual diagram of the learning processing as shown in FIG. 6.

### DETAILED DESCRIPTION

### Embodiment

### Configuration of Industrial Printing System X

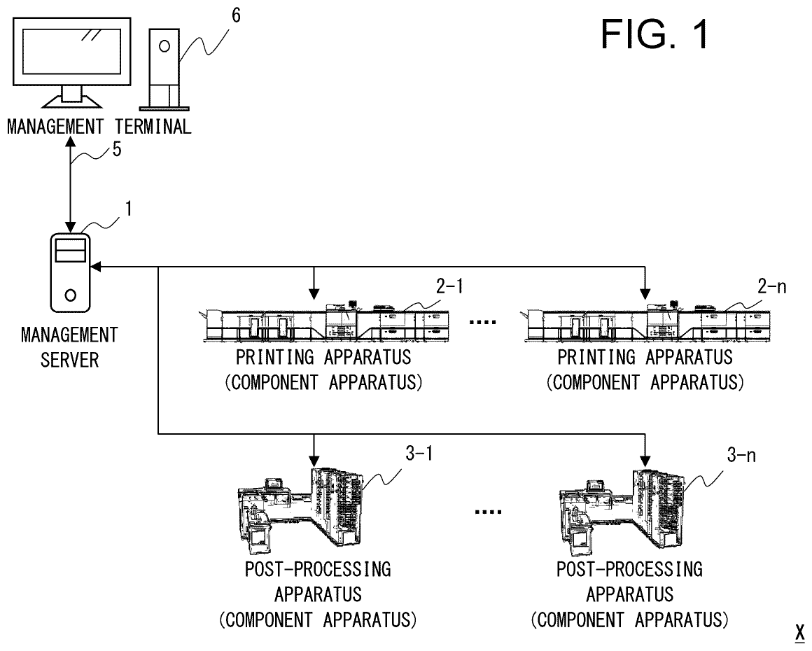

Firstly, referring to FIG. 1, an example of the overall system configuration of the industrial printing system X according to the present embodiment is described.

The industrial printing system X according to the present embodiment is a system that manages a workflow of an output of the printing process and post-processing process (hereinafter simply referred to as “printing”) in industrial printing (production printing.)

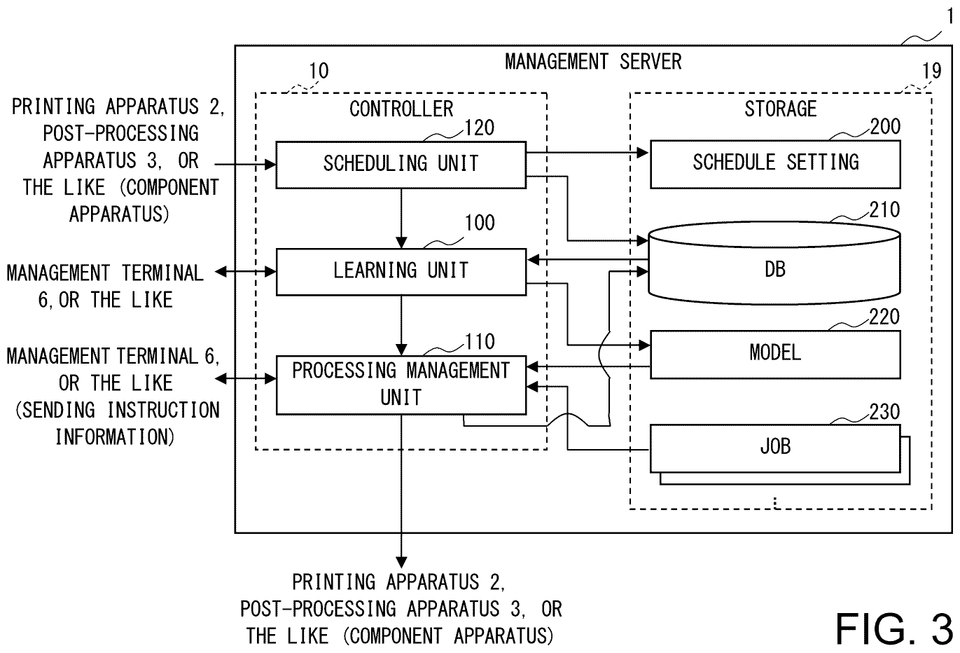

In the industrial printing system X according to the present embodiment, a final output of the printed book, or the like, is defined as an “order,” and each component of the order is defined as a job 230 (FIG. 3).

The industrial printing system X is installed at a printing company, printing factory, or other location.

In the industrial printing system X according to the present embodiment, a management server 1 controls printing-related apparatuses (hereinafter referred to as “component apparatuses”), which includes printing apparatuses 2-1 to 2-n and post-processing apparatuses 3-1 to 3-n. In addition, the management server 1 is also connected to a management terminal 6 used by a user such as the administrator of the industrial printing system X, and the like, via a network 5.

Hereinafter, when referring to one of the printing apparatuses 2-1 to 2-n, it is simply referred to as the printing apparatus 2. Similarly, when referring to one of the post-processing apparatuses 3-1 to 3-n, it is simply referred to as the post-processing apparatus 3.

The management server 1 is an information processing apparatus that acts as a print controller or a digital front end (DFE) to manage and control each component apparatus. The management server 1 is configured with a personal computer (PC), server, dedicated machine, general-purpose machine, or the like. In the present embodiment, the management server 1 allocates the processing of job 230 to each component apparatus to be managed, and it executes the processing according to the schedule.

In the present embodiment, the management server 1 sends and receives various instructions and information to and from the printing apparatus 2 and post-processing apparatus 3 in production printing. In this way, the management server 1 manages the status of each apparatus and requests processing of the job 230 (FIG. 3.)

In addition, in the present embodiment, the management server 1 manages the job 230 by executing dedicated printing management (order output management) application software (hereinafter simply referred to as “application”). This printing management application (hereinafter referred to as the “dedicated application”) may be executed on a common platform. On this common platform, printing design creation, user management, tenant management, security management, notification services for maintenance, prepress processing management, storage management of each document, management of each component apparatus, or the like, may be performed.

The printing apparatus 2 is an industrial printer, an automated offset printing apparatus, a digital printer, a multi-functional peripheral (MFP), and the like. The printing apparatus 2 is capable of performing printing processes such as small-lot printing or large-lot (multi-lot) offset printing.

In the present embodiment, printing apparatus 2 may differ in terms of the size, paper quality, color profile, recordable range, or the like, for the recording paper used in the printing process.

The post-processing apparatus 3 is an apparatus that can perform processing after printing (post-processing) of the printed paper, such as folding, collating, binding, trimming, binding, and the like.

The post-processing apparatus 3 of the present embodiment may also differ in the content and scope of the processing that can be performed in the post-processing process.

The network 5 is a local area network (LAN), wireless LAN (Wi-Fi), wide area network (WAN), cellular phone network, industrial network, voice telephone network, other dedicated line, or the like. The network 5 is capable of sending and receiving various commands and data with each apparatus. Furthermore, the management server 1 and each component apparatus may also be connected via a local area network (LAN), industrial network, or other in-house network within the premises of network 5. In addition, the network 5 may be configured as a virtual private network (VPN,) or the like.

The management terminal 6 is an information processing apparatus such as a PC, smartphone, tablet terminal, personal data assistant (PDA), dedicated terminal, or the like. The management terminal 6 is used by the administrator or other users to control printing. In the present embodiment, the management terminal 6 is capable of executing dedicated applications, connecting to the management server 1, and performing various settings and an instruction for print processing (hereinafter simply referred to as a “processing instruction.”) In the present embodiment, these processing instruction includes an instruction for an unprocessed job, an instruction for scheduling setting, a learning setting, a cost and quality check, and the like.

Also, the management terminal 6 can also execute applications that control the design and prepress of production printing. Furthermore, the management terminal 6 may be connected to other terminals for submitting data, design proofing terminals, or the like, for design and prepress. Furthermore, the management terminal 6 may also have functions for creating a job 230 and managing requests for processing by the management server 1. This enables the execution of functions such as acquiring a job 230, designing printing, submitting print jobs, managing prepress processing, checking progress status, and requesting processing.

In addition, there may be multiple of these apparatuses depending on the application or scale of printing. Moreover, the other component apparatuses managed by the management server 1 may be provided. Such other component apparatuses include, for example, a terminal for submitting a print job, terminal for design proofing, prepress apparatus, and the like.

In addition to the management server 1, the industrial printing system X according to the present embodiment may also be provided with a shipping management server that manages the shipping of the order sent after printing or post-processing is completed, a server of an upstream system of the management server 1, and the like. Furthermore, in addition, another general terminal used by the user may be connected with the network 5 inside and outside each location. The general terminal may include a so-called console.

Thus, the management server 1 can be accessed by the user from a management terminal 6 or a general terminal, or the like, with a web browser, terminal, dedicated application, or the like. Therefore, the user can acquire the job 230, allocate the job 230, design printing, submit printing, manage prepress processing, check progress, request processing, or the like.

### [Control Configuration of Management Server 1]

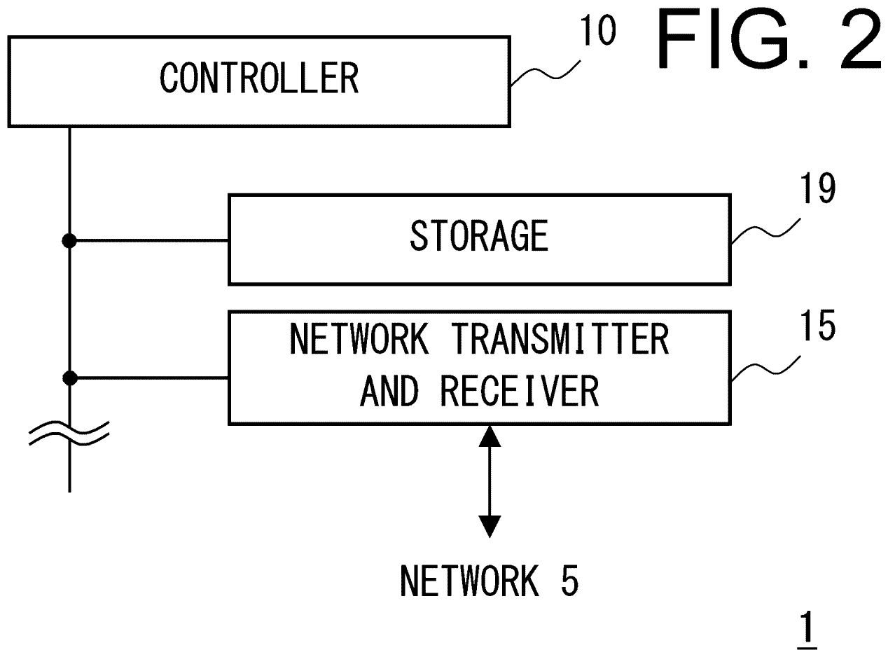

Next, referring to FIG. 2, the control configuration of the management server 1 is explained.

The management Server 1 includes a controller 10, a network transmitter and receiver 15, and a storage 19. Each unit is connected to the controller 10 and is controlled by the controller 10.

The controller 10 is an information processing circuit such as a general purpose processor (GPP), a central processing unit (CPU), a micro processing unit (MPU), a digital signal processor (DSP), a graphics processing unit (GPU), a neural processing unit (NPU), a tensor processing unit (TPU), and an application specific integrated circuit (ASIC).

In the present embodiment, the controller 10 is capable of accelerating artificial intelligence (AI) such as deep neural network (DNN), other machine learning, matrix operations for statistical calculations, or the like (hereinafter simply referred to as “AI, or the like”) by using a GPU, NPU, TPU, or the like. The controller 10 can perform learning operations on the model 220 in addition to output calculations from the generated model 220 (FIG. 3) at high speed.

The controller 10 reads the control program stored in the ROM or HDD in the storage 19, by expanding this control program in the RAM and executing it, and it can be made to operate as each part of the functional block as described later. In addition, the controller 10 controls the entire apparatus in response to the processing instruction input from the management terminal 6 or general terminal.

The network transmitter and receiver 15 is a network connection circuit that includes a LAN board and wireless transmitter and receiver for connecting to the network 5.

The network transmitter and receiver 15 transmits and receives data over data communication lines and transmits and receives voice signals over voice telephone lines.

The storage 19 is a non-transitory recording medium. The storage 19 includes semiconductor memories such as Read Only Memory (ROM) and Random Access Memory (RAM), and magnetic storage such as Hard Disk Drive (HDD), and the like. Among these, the ROM includes a rewritable recording medium such as a flash memory, and the flash memory may include a Solid State Drive (SSD).

The ROM and HDD in storage 19 store the control program for controlling the operation of management server 1. The control program includes the operating system (OS), middleware on the OS, services (daemons), various applications, database data, or the like. Among these, the various applications include the printing process management application as described above.

In the present embodiment, the storage 19 may store programs and data for performing raster-in-process (hereinafter abbreviated as “rasterize” or “RIP”), which converts vector (line drawing) image data into pixel image data (raster data) for printing. The programs and data for this rasterize processing include commercial libraries and fonts, or the like. In addition, the storage 19 may store information on connected component apparatuses, control programs, or the like.

Furthermore, the storage 19 may also store user account settings and other data for the industrial printing system X.

In the management server 1, the controller 10 may be formed as a CPU with a built-in GPU, a chip-on-module package, or a system on a chip (SOC).

The controller 10 may also have built-in RAM, ROM, or the like.

### [Functional Configuration of Management Server 1]

Here, referring to FIG. s 3 to 5, the functional configuration of the management server 1 is explained.

The controller 10 of the management Server 1 is provided with a learning unit 100, a processing management unit 110, and a scheduling unit 120.

The storage 19 stores a schedule setting 200, a DB 210, a model 220, and a job 230.

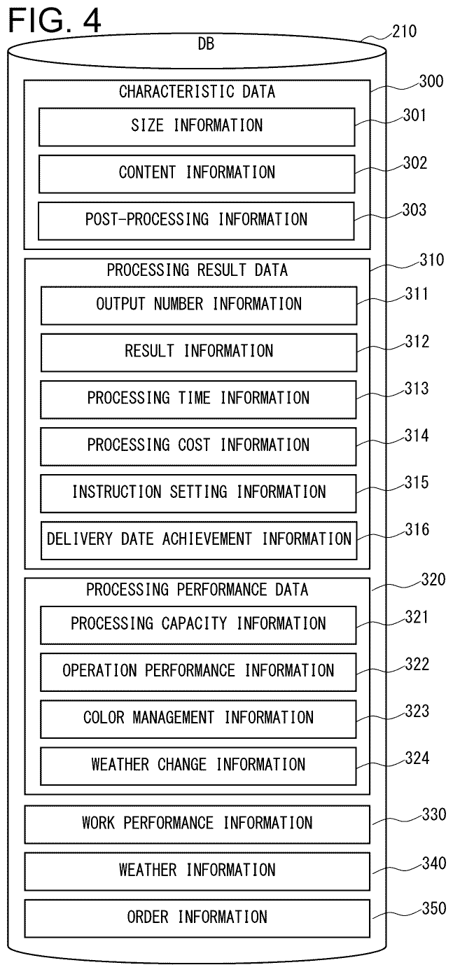

The learning unit 100 learns (trains on) the model 220 that shows the relationship between the settings of job 230 and the processing results and performances of the component apparatus based on characteristic data 300 (FIG. 4), processing result data 310, and processing performance data 320 stored in DB 210.

In the present embodiment, the learning unit 100 can also learn weather information 340 in the model 220.

Further, the learning unit 100 may also additionally learn the relationship between the operator who performs the work of allocating jobs 230 and issuing execution instructions (hereinafter simply referred to as “operator”) and the work performance information 330 in the model 220.

Further, the learning unit 100 may also additionally learn the relationship between the schedule setting 200 and the order information 350 in the model 220.

In addition, the learning unit 100 may learn the optimization of scheduling based on the instruction information 420 and the delivery date achievement information 316 in the model 220. Also, the learning unit 100 may learn the relationship between the order information 350 and the schedule setting 200 in the model 220.

The processing management unit 110 outputs information on the setting and scheduling allocation for an unprocessed job 230 to be processed at the optimal cost according to the instruction information 420 based on the processing instructions that include the condition to be prioritized, using the model 220. This output is performed by using the learned model 220, which is learned by the learning unit 100.

Alternatively, the processing management unit 110 can also output information on the settings and scheduling allocations for an unprocessed job 230 to be processed with optimal quality by the model 220 according to the instruction information 420 that includes the condition to be prioritized. This output is performed by the learned model 220, which is learned by the learning unit 100.

In the present embodiment, the processing management unit 110 also uses the model 220 to output information on the possibility of responding to sudden orders based on the processing instruction by the user via the management terminal 6.

The processing management unit 110 may also output information on the allocation of the operator.

Furthermore, the processing management unit 110 may allocate the unprocessed jobs 230 to the available space in the schedule setting 200 based on the output results of the model 220. In this way, the processing management unit 110 causes the unprocessed job 230 to be processed by the corresponding component apparatus.

Furthermore, the processing management unit 110 may send the job 230 itself, the data processed by the job 230, and processing status notifications and completion notifications to the management terminal 6. Thus, the processing management unit 110 may manage the processing of the job 230 according to the settings of the dedicated application.

The scheduling unit 120 centrally manages the processing of the jobs 230 in the component apparatuses with the schedule setting 200. In the present embodiment, the scheduling unit 120 manages the schedules for the processing of the printing apparatus 2 and the post-processing apparatus 3 in the schedule setting 200.

The schedule setting 200 is setting information that indicates the schedule status for the execution of each job 230. The schedule setting 200 includes, for each ID (identification) of a component apparatus, the processing schedule (allocation) or availability of the job 230, the processing status of the job 230, the operating status, a shipping record, or the like, in chronological order. Among these, the shipping record may be information related to the physical shipping of the printed matter after printing. The shipping record may include information such as the printing completion time, shipping time, receipt time, and the like.

The DB 210 is a processing database that stores the characteristic data 300 and processing result data 310 of processed jobs 230, processing performance data 320 of component apparatuses, and other data.

The details of the DB 210 are described later.

The model 220 is model data of AI, or the like. In the present embodiment, the model 220 may include a model that shows the relationship between the settings of job 230 and the processing results and performance of the component apparatus.

For this reason, in the model 220, the characteristics, processing results, and processing performances of the processed jobs 230 are learned. In the present embodiment, in the model 220 the relationship between the operator and the work performance information 330 may also be learned. In addition, in the model 220, the weather information 340 may also be learned.

Furthermore, in the model 220, the relationship between predictions and actual results in scheduling when jobs 230 are allocated to the available space in the schedule setting 200 may also be learned.

Also, in the model 220, the relationship between the schedule setting 200 and order information 350 may be learned.

Among these, the model 220 may be either single model or compound models in which each model is connected. It is also possible to use a CNN (Convolution Neural Network), GMM (Gaussian Mixture Model), Transformer, kNN (k-Nearest Neighbor), Bayesian network, kernel machine, decision tree, and other various machine learning and statistical models.

The job 230 is data that summarizes various data used during printing in production printing. The job 230 may be described in, for example, job description format (JDF) and/or job messaging format (JMF).

Details of the job 230 are described later.

### (Details of DB 210)

Then, as refer to FIG. 4, the details of the DB 210 are described.

In the present embodiment, the DB 210 includes characteristic data 300, processing result data 310, processing performance data 320, work performance information 330, weather information 340, and order information 350.

The characteristic data 300 is detailed processing data that shows the characteristics of the job 230.

In the present embodiment, the characteristic data 300 may be data that enables the characteristics of the job 230 to be analyzed. Specifically, data relating to the characteristics of the job 230, such as monochrome printing jobs that are transactions with large number of pages but not large data size, color printing jobs with small number of pages but large data size including photos with spot colors, and the like, are stored.

The processing result data 310 is data that summarizes various information on the processing results of the actual processing of the job 230. In this embodiment, the processing result data 310 is stored as data that allows the processing result to be analyzed for each characteristic of the job 230.

The processing performance data 320 is data on the processing performance of the printing or post-processing by the component apparatus. In the present embodiment, the processing performance data 320 accumulates data that can be analyzed for the processing capacity of each component apparatus for the job 230.

Details of the characteristic data 300, the processing result data 310, and the processing performance data 320 are described later.

The work performance information 330 is information on the work results of the operators. In the present embodiment, the work performance information 330 includes the ID of each operator's account and work data. The work data may include the number of work jobs and work time for each characteristic of job 230 as data related to the operation cost of the operator. Furthermore, the work data may also include data related to the print quality of the operator. The data related to work costs and print quality may include information about the result of processing errors. The information about the result of processing errors includes the type of error, the number of times it occurred, and the date and time of the error. Furthermore, as actual results of the print inspection, it may also include information on the inspection OK or NG results and their content, or the like, for each characteristic of the job 230, which includes information on defective areas and color difference (ΔE).

The weather information 340 is information about the weather when the job 230 has been processed. The weather information may be the values of temperature, humidity, and the like, at the time of being processed the job 230. The value of temperature or humidity may be the temperature or humidity acquired by a sensor at the installation location where the component apparatus is installed, or the temperature or humidity outdoors. Further, the value of temperature and humidity may include data such as temperature and humidity acquired by sensors provided in the component apparatus, or temperature and humidity acquired from a weather information server. Furthermore, the weather information 340 may include information on short-term or long-term forecasted weather.

The order information 350 is information on orders on a calendar.

In the present embodiment, the order information 350 may be information that can be used to analyze busy periods for orders, trends in sudden orders, or the like. Thus, the order information 350 may be information on the forecast and performances of orders on the calendar. Further, the order information 350 may include actual results information when processing sudden orders. Furthermore, the order information 350 may include processing instructions from the user, such as delivery dates and priorities. This processing instructions may correspond to instruction information 420, which is described later.

Furthermore, in the present embodiment, the order information 350 may also include information on the result of scheduling (hereinafter referred to as a “scheduling result”). The scheduling result is data indicating the result of scheduling by the processing management unit 110. The scheduling result may indicate, for example, the time to be the allocated job 230 based on the schedule settings 200, the processing time and average processing completion time of the allocated jobs 230, and overall cost and quality results, which includes consumable quantities and costs.

Here, the details of the characteristic data 300 are explained.

In the present embodiment, the characteristic data 300 include size information 301, content information 302, and post-processing information 303.

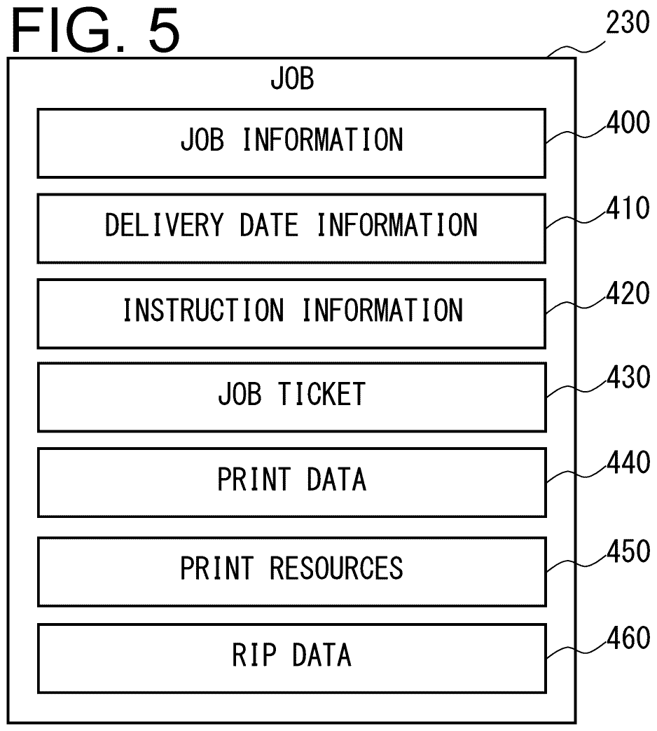

The size information 301 is information about the size characteristics of the job 230 calculated from the job information 400 (FIG. 5), print data 440, and print resources 450, or the like, in the job 230. For example, the size information 301 includes information such as data size, number of pages, paper size, dots per inch (DPI), or the like.

The content information 302 is information about the content obtained from the job 230. For example, the content information 302 includes preflight information, profile information, font information, image data information, or the like.

The post-processing information 303 is information about post-processing job 230 and the processing of post-processing of printing job 230.

Then, the details of the processing result data 310 is explained.

In the present embodiment, the processing result data 310 includes information on the processed component apparatus, output number information 311, result information 312, processing time information 313, processing cost information 314, instruction setting information 315, and delivery deadline achievement information 316.

The information on the processed component apparatus includes an ID to identify the component apparatus that has been processed for each job 230.

The output number information 311 is information on the number of printed output sheets and copies when processing the job 230.

The result information 312 is information indicating the results of printing and post-processing. Specifically, the result information 312 includes information indicating the results of whether or not there have been any successes, errors, or wastage.

The processing time information 313 is information on the processing time taken for printing and post-processing of the job 230.

The processing cost information 314 is information on the cost of ink used, paper used, or the like, taken for processing the job 230.

The instruction setting information 315 includes information on the user's processing instructions for the job 230 and information on the instructions given by the operator. These instructions include information on the condition to be prioritized, such as cost priority, quality priority, or the like. These condition to be prioritized may be the same as the conditions in the instruction information 420 for the job 230, which is described later. These conditions can be set by the user by using the GUI on the management terminal 6.

The delivery date achievement information 316 is information on the predicted and actual processing of the job 230. In other words, the delivery date achievement information 316 is information on the actual processing schedule compared to the planned processing schedule.

In the present embodiment, the delivery completion information 316 includes information such as the difference between the date and time set in the delivery date information 410 (FIG. 5) for the job 230 and the completion date and time, and how much time has been available, and the like. Furthermore, the delivery completion information 316 includes information such as whether the job has been a job that had been planned in advance or a job that has been suddenly ordered, or the like. This makes it possible to accumulate data that can be used to analyze the degree of completion of delivery for each characteristic of the job 230.

Then, the details of the processing performance data 320 are explained.

In the present embodiment, the processing performance data 320 includes processing capacity information 321, operation performance information 322, color management information 323, and weather change information 324.

The processing capacity information 321 is performance information on the number of processing jobs and processing time for each characteristic of the job 230. This performance information includes information on the processing of job 230, which is other costs, and the like. Further, the processing capacity information 321 includes information that can be analyzed for a processing result and processing performance for each characteristic of the job 230.

In the present embodiment, the processing capacity information 321 also includes information on the error history of the component apparatus. The information on the error history includes performance information such as the error details, the number of times it occurred, the date and time it occurred, the time required to recover from the error, and the like.

Furthermore, the processing capacity information 321 includes performance information on the inspection results. The performance information on the inspection results includes the OK/NG results of the inspection, color difference (ΔE) information, or the like, for each characteristic of the job 230.

Furthermore, the processing capacity information 321 includes performance information on the set change work of the component apparatus. The performance information on the set change work is the performance information on the work of changing the settings of the recording paper and other components.

Furthermore, the processing capacity information 321 may also include actual information on the jobs 230 processed by batch processing, which processes the same processing together, and ganging processing, which processes the same print-processable jobs together on a single sheet of recording paper.

The operation performance information 322 is information on operational performance for the component apparatus. In the present embodiment, the operation performance information 322 accumulates data that allows the operation rate of the component apparatus to be analyzed based on the operational performance to the schedule.

In the present embodiment, the operation performance information 322 may be information on operational performance related to the printing cost and printing quality of the component apparatus. More specifically, the operation performance information 322 may include information on operational performance for the operational period and time of the component apparatus.

In addition, the operation performance information 322 may include information on the maintenance time, maintenance content, and work date and time as the maintenance performance information of the component apparatus.

Furthermore, the operation performance information 322 may include information on the operating time, non-operating time, and free time of the component apparatus.

The color management information 323 is information on the results of color management processing for component apparatuses. In the present embodiment, it includes information on color management operation and color fluctuation status when scheduling and processing the job 230. This allows data to be accumulated that can be used to analyze how often color management should be performed and color correction should be performed.

In the present embodiment, the color management information 323 includes performance information on color management operation. This information includes the content of the color management operation, the operation date and time, the time elapsed since the previous color management operation, the number of jobs processed, information about the content of the processed jobs, and the like. The information about the content of the processed jobs may also include information about the number of printed sheets, the amount of ink consumed, or the like.

As color variation information, the color management information 323 may include information on the status of color variation against the threshold value. This information on the status of color variation may include information indicating the status of color variation relative to the threshold value.

The weather change information 324 includes information on the weather of the component apparatus in addition to the temperature, humidity, or the like, when processed in the same way as the weather information 340 as described above.

Specifically, the weather change information 324 may include information set to correct paper shrinkage caused by the weather, information on the printing results due to changes in the ink state caused by the weather, or the like.

### (Details of Job 230)

Then, as refer to FIG. 5, the details of the job 230 are explained.

In the present embodiment, it is mainly explained the data used in rasterization, printing, and post-processing for the job 230.

the job 230 includes, for example, job information 400, delivery date information 410, instruction information 420, job ticket 430, print data 440, and print resources 450 (hereinafter, these are also referred to as “data contents.”) The job 230 may also include RIP data 460 as the data contents.

The job information 400 is data that includes attributes specified in the printing process (hereinafter referred to as “specified attributes.”) As the specified attributes, the job information 400 sets the type of job 230, the name of job 230, the name of the project (order), the designation of the printing apparatus 2 or post-processing apparatus 3, the number of copies and whether or not collating is to be performed, whether or not recording is to be performed, the millimeter of trimming from the edge, the printing direction, the printing status, the priority, or the like. Among these, the types of job 230 include a job that performs rasterization (a rasterization job), a job that performs printing (a printing job), and a job that performs post-processing (a post-processing job).

The delivery date information 410 is information on the delivery date of the job 230. This delivery date information can be set to one or more types of delivery time information, such as the delivery date and time, and the desired completion date and time, or the like.

Among these, the delivery date and time is the absolute due date and time specified by the user or upstream system that must be completed. The desired completion date and time is the date and time when the job is desired to be completed with respect to the due date and time. This desired completion date and time may correspond to the threshold setting as described later.

Further, the delivery date information 410 may include information on the estimated time of completion output during scheduling.

Furthermore, in the present embodiment, the delivery date information 410 also stores data such as whether the job 230 is a processed job that has already been processed or an unprocessed job.

The instruction information 420 is information on the user's processing instructions, which includes the condition to be prioritized for the job 230. Specifically, the instruction information 420 may include a priority setting for whether to prioritize the delivery date, the operating rate, or the number of processed jobs.

Among these, the instruction to prioritize the delivery date is an instruction to prioritize the delivery date in the delivery date information 410 and to perform processing with as much time as possible before the delivery date. The instructions that prioritize operating rate, for example, are instructions that maximize the operating rate within a specific period, such as the operating rate per day, or the like. The instructions that prioritize the number of processing jobs, for example, are instructions that maximize the number of processing jobs within a specific period, such as the number of processing jobs per day, or the like.

Further, the instruction information 420 may include setting information as to whether or not to prioritize the cost of processing. Also, the instruction information 420 may include settings for priorities related to the output of the job 230, such as the type of component apparatus, paper type, and post-processing type, or the like, at the time of output of the job 230. In addition, in the present embodiment, the instruction information 420 may also include reservation information that specifies the printing apparatus 2 or post-processing apparatus 3.

The job ticket 430 is setting data that includes print instruction attributes for requesting a job 230. The job ticket 430 includes necessary settings in the printing process and post-processing process, such as lower settings in the workflow, which are order settings, for example, color mode instruction, imposition instructions, paper specifications, binding specifications, or the like.

The job ticket 430 may also be described in JDF and/or JMF.

The print data 440 is data of a print document whose design is set according to the order. The print data 440 may be, for example, electronic document data such as portable document format (PDF) data, post script (PS) data, other vector data, data in a format for submitting a manuscript, or other raster image data.

The print resources 450 are various resource information necessary for printing instructions such as color mode and font. These various resources may be referenced by the model 220.

Other resource data necessary for printing may also be included in this printing resource 450.

The RIP data 460 is data such as PDF that includes image data that has been rasterized based on the job ticket 430. This image data may be, for example, TIFF or other bitmap data. In addition, the image data may be lossless or lossy compressed.

In addition, the job 230 may also include information on schedule changes, information on processing changes when actually processed, and other information.

In addition, in the present embodiment, the DB 210 may also include information on the processing capacity and status of each component apparatus. This information on the processing capacity of the component apparatus may be information on the capacity that can be processed in rasterization, printing, and post-processing, as well as information on processing time and output speed (hereinafter referred to as “throughput”). Also, the status information may be information on the paper and consumables that have been set, as well as information indicating the operating status and maintenance, or the like.

Further, in the present embodiment, the DB 210 may temporarily store the user's processing instructions via the management terminal 6. This user's processing instructions may be set in the instruction setting information 315 of the processing result data 310.

Further, in the present embodiment, the DB 210 may include estimate data. The estimate data may be data of an estimate for processing the job 230. For example, the estimate data may include estimates of the time for printing and post-processing, estimates of the amount of consumables such as ink and paper, and estimates of other costs.

In addition, the DB 210 may also include alternative settings for substitutable capabilities and settings. These alternative settings may be set to indicate whether or not a color mode, font, or the like, can be substituted. Furthermore, the alternative settings may also include settings such as the extent to which alternatives are allowed when alternatives are possible, and the like.

In the present embodiment, these alternative settings may be set by the user by using a dedicated application.

Here, the controller 10 of the management server 1 is cause to function as processing management unit 110, learning unit 100, processing management unit 110, and the scheduling unit 120 by executing the control program stored in the storage 19.

In addition, each part of the management server 1 described above is a hardware resource that executes the processing management method according to the present disclosure.

Furthermore, some or any combination of the above functional components may be configured in hardware or circuitry using ICs, programmable logic, field-programmable gate array (FPGA), or the like.

### [Job Order Process by Management Server 1]

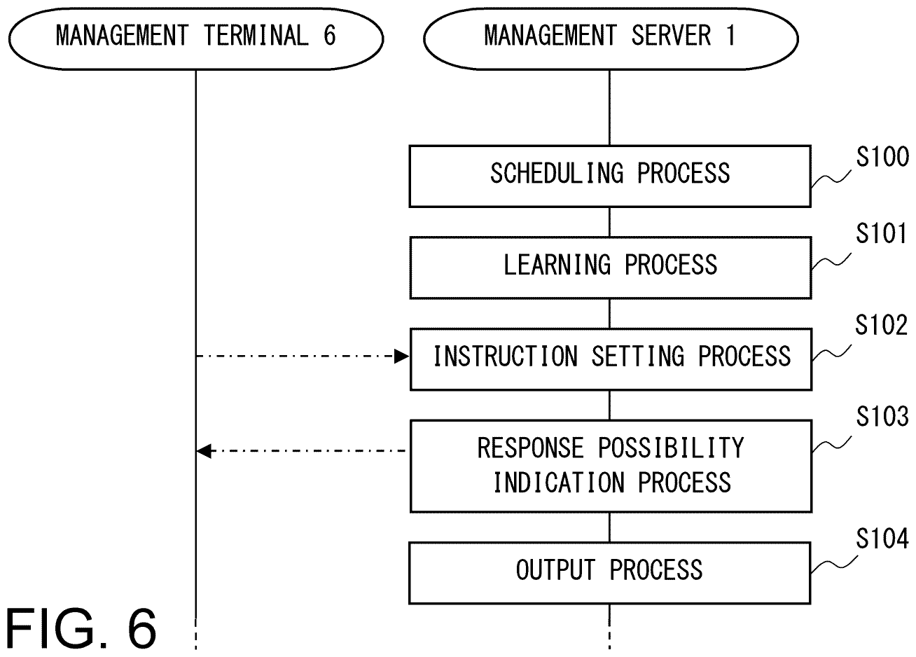

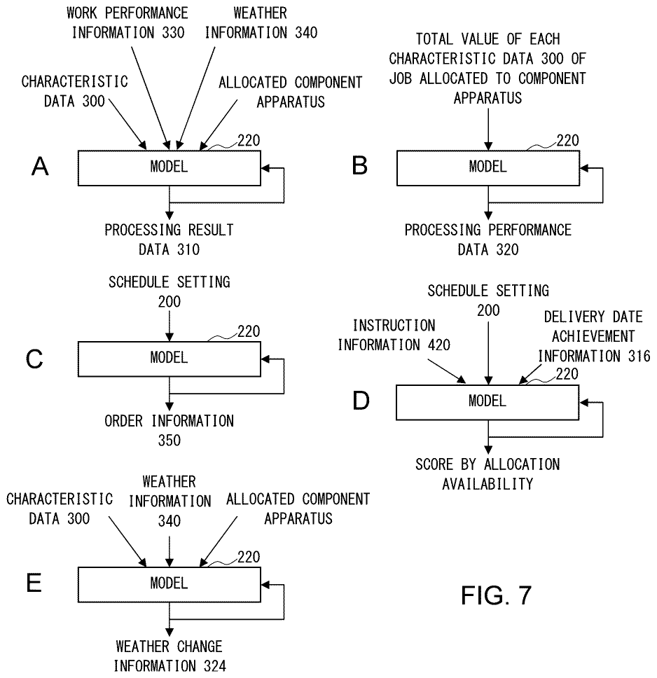

Next, referring to FIGS. 6 and 7, a job order process performed by the management server 1 in accordance with the embodiments of the present disclosure is explained.

In the job order process according to the present embodiment, the schedule setting 200 for processing the job 230 of the component apparatus is centrally managed. Then, the characteristic data 300 and the processing result data 310 of the processed jobs 230 and the processing performance data 320 of the component apparatus are stored. Then, based on the characteristic data 300, the processing result data 310, and the processing performance data 320 stored in the DB 210, a model 220 that optimally allocates 230 jobs to component apparatuses is learned. Based on the output results of the model 220 for the unprocessed job 230, the unprocessed job 230 is allocated to an available space in the schedule setting 200 and processed by the corresponding component apparatus according to the instruction information 420 that includes the condition to be prioritized.

In the job order process of the present embodiment, the controller 10 of the management server 1 mainly executes the program stored in the storage 19 in cooperation with each unit by using hardware resources.

The details of the job order process are explained below, step by step, with reference to the flowchart in FIG. 6.

### (Step S100)

Firstly, the scheduling unit 120 performs scheduling process.

The scheduling unit 120 centrally manages the schedule setting 200 for processing of the job 230 of the component apparatus.

In the present embodiment, for the printing apparatus 2 and post-processing apparatus 3 (component apparatuses) managed by the management server 1, the schedule setting 200 for processing the job 230 is shared throughout the industrial printing system X. For this reason, the scheduling unit 120 connects to each component apparatus and grasps the processing status and completion status of the job 230. The status is then reflected in the schedule setting 200 and updated in real time. This enables the scheduling unit 120 to centrally manage the free schedules of each component apparatus in the schedule setting 200.

Furthermore, the scheduling unit 120 can also acquire information on processing capacity and status from each component apparatus as needed and set this in the schedule setting 200.

On this basis, the scheduling unit 120 sets the delivery date information 410 for the job 230 after processing to indicate that it has been processed. Then, the scheduling unit 120 stores various information including information about this job 230, information on the allocated component apparatus, and the various information of availability of the schedule in the DB 210.

Furthermore, the scheduling unit 120 can store various data about the processing of the job 230 in the DB 210.

### (Step S101)

Then, the learning unit 100 performs the learning process.

The learning unit 100 refers to the DB 210 as training data for the model 220, which is AI, or the like, and learns the model 220 based on data such as the characteristic data 300 of the job 230, the processing result data 310 for each job 230, the processing performance data 320 of the component apparatus, the work performance information 330, the weather information 340, and the order information 350.

The learning unit 100 can use various machine learning (ML) methods as the learning method, and especially, the most suitable method for each type of the model 220 can be used. For example, supervised learning such as BP (Backpropagation) and EM algorithms, unsupervised learning, reinforcement learning, statistical estimation, or the like, can be used.

As refer to FIG. 7, a specific example of this learning process is explained.

As refer to “A,” the learning unit 100 inputs characteristic data 300, the specification of the allocated component apparatus, the work performance information 330, and the weather information 340 for each processed job 230, and by using these data, it trains a model 220 such that each piece of information in the processed result data 310 (as teacher data) is similarly output. Thus, the learning unit 100 learns the model 220 that indicates the relationship between the job 230 and the processing result. As a result, it is possible to learn the model 220 to output the cost and/or quality of an allocating job 230.

As refer to “B,” in addition, the learning unit 100 also learns a model 220 in which the sum of the characteristic data 300 of all allocated and processed jobs 230 for each component apparatus is input and information on each piece of processing performance data 320 (as teacher data) is similarly output. As a result, it is possible to learn the model 220 that indicates the performance for each characteristic of the job 230 for a specific component apparatus.

As refer to “C,” furthermore, the learning unit 100 also learns a model 220 in which the schedule setting 200 is input and the busy period for orders or a trend in sudden order is similarly output as the order information 350. In other words, the order information 350 becomes the teacher data for this model 220. This makes it possible to learn a model 220 that shows the relationship between the schedule setting 200 and the order information 350.

As refer to “D,” here, the learning unit 100 also learns about scheduling optimization based on the instruction information 420 and the delivery date achievement information 316. The learning unit 100 performs a simulation of allocation to the schedule setting 200 based on the output of each of the trained models 220 described above when each of the processed jobs 230 is allocated in various combinations. Then, the learning unit 100 calculates availability information of the schedule setting 200 by the simulation based on the delivery date achievement information 316, and it uses this as a score to learn the model 220 so as to achieve optimal allocation. For example, the score may be increased when the schedule setting 200 has less free space, many jobs 230 are assigned in a short period of time, and the operating rate of each job increases. At this time, the printing quality may also be added to the score.

As refer to “e,” furthermore, in the present embodiment, the learning unit 100 can also learn a model 220 about the relationship between the weather and the weather corrections by inputting the weather information 340, the characteristic data 300 of each job 230, and the specification of the allocated component apparatus, and by using the weather change information 324 as teacher data for BP, or the like.

Here, the learning unit 100 may learn each individual model 220 for each piece of information that is output, or it may learn an integrated model 220. The same applies to other information. In addition, each value that is input may be normalized as appropriate, or it may be convolved as appropriate for input to the model 220.

Further, the learning unit 100 may generate a model 220 that combines the processing capacity and state of the component apparatus.

Furthermore, the learning unit 100 can also present the state of the generated model 220 to the user via graphical user interface (GUI) of the dedicated application on the management terminal 6.

### (Step S102)

Then, the processing management unit 110 performs the instruction setting process.

The processing management unit 110 acquires an unprocessed job 230 from the management terminal 6, the inter-site management system upstream of the industrial printing system X, the user's other terminal, prepress apparatuses, or the like, and stores it in the storage 19, sequentially. The job 230 may be created by the management terminal 6 for a manuscript submitted by the submission terminal. Further, when the job 230 is acquired, the scheduling unit 120 may set the delivery date information 410 of the job 230 to be the unprocessed job 230.

In this case, the processing management unit 110 may acquire the characteristic data 300 of the unprocessed job 230. Specifically, the size information 301, content information 302, and post-processing information 303 of the unprocessed job 230 may be acquired and stored.

At this point, the processing management unit 110 acquires the user's processing instructions for the unprocessed job 230 from the management terminal 6. This processing instructions are based on the instruction information entered by the user by the GUI of the dedicated application.

At this time, the processing management unit 110 may acquire the characteristics of the job 230 from the processing instructions. As the processing instructions, the processing management unit 110 may acquire instructions for the information of the unprocessed job 230, the information of the processing target component apparatus, the order information 350, and the information of the operator.

In this case, as the information of the unprocessed jobs 230, information for setting characteristic data 300 for each job 230 can be obtained.

The information of the processing target component apparatus can be the ID of a specified component apparatus or group of apparatuses for each job 230 or other specific information for which each job 230 is allocated.

As instructions for the order information 350, information for setting delivery dates and priorities can be obtained.

As for the information of the operator, it is possible to acquire information for setting the information for instructions to the operator and the work performance information 330. Based on this information for instructions to the operator, the operator operates for printing.

In addition, the processing management unit 110 may acquire data such as temperature and humidity, and the forecast weather information 340, or the like, from the weather information server.

The processing management unit 110 sets these user instructions to each data.

In addition, the processing management unit 110 may store the above-mentioned user instructions in the instruction setting information 315 of the processing result data 310 of the DB 210. These instructions include the instructions for the condition to be prioritized and the threshold settings as described later.

These instructions for the condition to be prioritized may be a condition for prioritizing quality, costs, delivery date, operating rate, or the number of processing jobs.

Among these, the condition for prioritizing quality may be a condition that ensures printing quality as much as possible.

Also, the condition for prioritizing costs may be a condition that keeps costs down as much as possible.

Also, the condition for prioritizing delivery date may be a condition that processes jobs with as much time as possible to spare for delivery.

Also, the condition for prioritizing operating rate may be a condition that maximizes the operating rate within a specific period, for example, the operating rate of a component apparatus per day.

Also, the condition for prioritizing the number of processing jobs may be a condition that maximizes the number of processing jobs within a specific period, for example, the number of processing jobs per day.

The processing management unit 110 is able to acquire these processing instructions and set them in the DB 210 and the unprocessed jobs 230.

In addition, the setting of the conditions to be prioritized may be able to set conditions such as whether to apply, prioritize, or not apply the instruction information 420 of the job 230.

Further, the threshold setting is a setting of conditions for scheduling and starting execution of the job 230. In the present embodiment, the threshold setting includes a setting that indicates a threshold condition for the completion processing time of the job 230. Specifically, the threshold setting can set threshold conditions such as the earliest time for the estimated completion time of each job 230 to exceed the threshold date and time first, or the latest time for the estimated completion time of each job 230 to exceed the threshold date and time first. This threshold date and time can be set by the user to a time period of several hours to several days. The threshold setting may be referred to when scheduling the actual allocation of job 230.

### (Step S103)

Then, the processing management unit 110 performs a response possibility indication process.

The processing management unit 110 outputs the processing possibility of sudden orders by using the model 220 that has learned the relationship between the schedule setting 200 and the order information 350 described above.

In other words, it presents to the user on the GUI of the management terminal 6 the possibility of whether or not a job 230 can be allocated from the state of the schedule setting 200 in the first place.

### (Step S104)

Then, the processing management unit 110 performs the output process.

If the user has examined the possibility of allocation and has instructed an allocation, the processing management unit 110 uses the model 220 to output information on the settings and scheduling allocation of the job 230 for processing under the condition to be prioritized.

Specifically, the process management unit 110 causes the model 220 to output a plurality of settings for the job 230 and the scheduling allocation based on the condition to be prioritized, and it calculates the optimal combination. In this case, the processing management unit 110 may score the processing results and processing performance and select the optimal combination. Alternatively, the processing management unit 110 may calculate this optimal combination by analyzing the learned model 220.

On this basis, the processing management unit 110 outputs information including the printing cost and predicted quality of the calculated optimal combination.

Specifically, as the information for setting and scheduling allocation of the optimal combination of the job 230, the processing management unit 110 outputs information such as the optimal component apparatus, optimal operator, optimal processing settings, optimal scheduling time, and the like. Among these, the optimal processing settings include the optimal paper, color profile, and the like.

Furthermore, the processing management unit 110 can also output a combination of unprocessed jobs 230 that can be processed by ganging printing based on the conditions to be prioritized.

In addition, the processing management unit 110 can also output a correction setting based on the model 220 of the relationship between the weather and the weather forecast. This correction setting includes a scaling setting to correct paper enlarge/shrinkage and a color profile setting to correct the ink state.

More specifically, the processing management unit 110 may output information for an unprocessed job 230 as follows:
Printing cost: $ X,XXX
Optimal component apparatus: Printing apparatus 2-1
Optimal operator: Operator-X
Optimal printing settings: Color profile (XYZ)
Optimal scheduling: 1/20 11:00-11:30

In such case, if the condition to be prioritized is cost, the processing management unit 110 outputs the above information about the component apparatus that can be printed with the lowest cost and the lowest color difference (ΔE) criteria, the ID of the operator with the lowest cost of work, settings, allocating time, or the like.

Furthermore, the process management unit 110 can output a combination that collects as many ganging-possible jobs 230 as possible and outputs them at a reduced cost.

On the other hand, in the case that a condition to be prioritized is quality, the processing management unit 110 outputs information such as component apparatuses that can be printed with high color difference (ΔE) criteria, IDs of the operator with a lot of work experience regarding the characteristics of the corresponding job 230, printing settings, allocating time, or the like.

Furthermore, the processing management unit 110 can also output a combination that only collects jobs 230 that can be performed ganging with high printing quality.

Based on the output, the processing management unit 110 can also perform scheduling to allocate the jobs 230 to the available space in the schedule setting 200 based on the setting values of the condition set by the user.

The processing management unit 110 can cause the corresponding component apparatus process the job based on the allocation.

Here, when the processing management unit 110 allocates the job 230 to the schedule setting 200, it may calculate the estimated time for completion of processing for the job 230 and set it in the delivery date information 410. The estimated time for completion of processing may be calculated based on the processing capacity and status information of the component apparatus allocated in the schedule setting 200. For example, the processing management unit 110 may calculate the expected process completion time based on the expected process time at the allocated space in the schedule setting 200. Furthermore, the process management unit 110 may calculate the expected process completion time of the job 230 and set it in the job 230 itself and the schedule setting 200.

More specifically, the processing management unit 110 may calculate the processing time for each job 230 based on the number of pages to be printed and the average throughput (Page Per Minutes) of the allocated component apparatus, or the like. Furthermore, the processing management unit 110 may similarly calculate costs other than the process time, such as the amount of consumables, or the like.

Furthermore, when allocating each job 230, the processing management unit 110 may present the job 230 itself as an error if the delivery date and time in the delivery date information 410 is exceeded.

The processing management unit 110 stores the scheduling output in the schedule setting 200 as the scheduling result.

Here, the processing management unit 110 may send the scheduling result again to the dedicated application of the management terminal 6.

The GUI of the dedicated application on the management terminal 6 can display the processing cost, processing time, amount of consumables, other costs, predicted quality, or the like, of the job 230. This allows the user to check the scheduling results on the GUI, and to change the processing instructions themselves, modify or select the model 220, or the like.

As a result of this processing, the printing process is started, and rasterizing, printing processing, or post-processing is executed by the allocated component apparatus for the job 230. The processing management unit 110 may send the processing status notification and completion notification of the job 230 to the management terminal 6 before and after this processing request and processing completion. In other words, the processing management unit 110 can manage the processing status and processing completion.

In addition, the processing management unit 110 may perform repeated scheduling and optimally allocate job 230 when there is availability.

This completes the job order process according to the embodiment of the present disclosure.

The following effects can be obtained by the above configuration.

In a typical production printing system, digital printing has the advantage of being able to print a wide variety of printing, such as personalized printing, from small lots. On the other hand, digital printing has a higher cost than offset printing.

The cost of a production printing job includes the cost of the paper used, the ink used, the electricity and depreciation costs associated with using the component apparatuses, and the labor costs of the operators. Optimization to reduce these costs is carried out based on the experience of the operators. For this reason, it is a task that is dependent on the operator, and it is not always efficient.

In contrast, the industrial printing system X of the present embodiment is an industrial printing system that performs production printing having a component apparatus and a management server, including: a DB 210 that stores characteristic data 300 and processing result data 310 of processed jobs 230 and processing performance data 320 of the component apparatus; a learning unit 100 that learns a model 220 that shows relationship between the settings of jobs 230 and processing results and performances of component apparatuses based on the characteristic data 300, processing result data 310, and processing performance data 320 stored in DB 210; and a processing management unit 110 that outputs information on a setting of a job 230 and scheduling allocation for processing at the optimal cost based on the model 220 learned by the learning unit 100 in accordance with instruction information 420 that includes condition to be prioritized.

As configured in this way, with regard to the optimization of printing costs, which is currently a matter of personal judgment, the machine learning model 220 is trained by using information that is a factor in the printing cost, and the optimal cost for the job 230 and scheduling can be set. This makes it possible to process the job 230 at the optimal printing cost.

On the other hand, in typical production printing systems, there is a constant demand for high print quality, so there is a need to reduce printing costs and improve processing efficiency while ensuring print quality.

In contrast, the industrial printing system X of the present embodiment is an industrial printing system that performs production printing having a component apparatus and a management server, including: a DB 210 that stores characteristic data 300 and processing result data 310 of processed jobs 230 and processing performance data 320 of the component apparatus; a learning unit 100 that learns a model 220 that shows relationship between the settings of jobs 230 and processing results and performances of component apparatuses based on the characteristic data 300, processing result data 310, and processing performance data 320 stored in DB 210; and a processing management unit 110 that outputs information on a setting of a job 230 and scheduling allocation for processing at the optimal quality based on the model 220 learned by the learning unit 100 in accordance with instruction information 420 that includes condition to be prioritized.

As configured in this way, the system can learn from the information that is the cause of the problem in order to optimize costs and processing while maintaining print quality, and it can indicate the optimal processing settings. Therefore, with regard to the optimization of printing costs, which is currently a matter of personal judgment, the system can perform the most optimal job 230 settings and scheduling within the range of printing quality that meets the priority conditions.

Further, the skill-less automation of the schedule allocation, which had been a task that depended on the operator's skills, is possible. Therefore, optimal scheduling at any time from the data accumulated in the processing can be performed. Furthermore, it is possible to learn from the daily processing results and optimize the schedule at any time. Therefore, the job 230 can be processed efficiently.

In such case, by using the instruction information 420, optimal scheduling based on the conditions to be prioritized can be performed.

Further, in the industrial printing system X of the present embodiment, the DB 210 further stores the operator's work performance information 330, the learning unit 100 learns the relationship between the operator and the work performance information 330 in the model 220, and the processing management unit 110 outputs the information on the allocation of the operator.

As configured in this way, the optimal operator can be allocated for job 230. This allows the optimal operator to process the job in terms of cost and quality, and printing to be carried out according to the user's objectives.

Further, in the industrial printing system X of the present embodiment, the DB 210 further stores the weather information 340 when processing, and the learning unit 100 also learns the weather information 340 in the model 220.

As configured in this way, the relationship between the weather information 340 and the weather change information 324 can also be learned to the model 220, and corrections can be made according to the forecasted weather. This allows automatic, objective, and high-quality weather correction, rather than relying on personal adjustments. This reduces waste, or the like, and also reduces costs.

In the industrial printing system X of the present embodiment, the DB 210 further stores order information 350 that indicates busy periods for orders and a trend in sudden orders, and the learning unit 100 also learns the relationship between schedule setting 200 and order information 350 in model 220.

By configuring it in this way, it is possible to perform scheduling at optimal cost and quality according to the relationship between the schedule and the order.

In the industrial printing system X of the present embodiment, the processing management unit 110 outputs the possibility of handling a sudden orders based on the model 220.

As configured in this way, it is possible to present to the user the expected number of sudden orders, that is, how many sudden orders can be handled. This allows for scheduling by setting available times for component apparatuses in preparation for unexpected orders for the jobs 230.

In the industrial printing system X of the present embodiment, the characteristic data 300 of the job 230 includes size information 301, content information 302, and post-processing information 303, the processing result data 310 includes output number information 311, processing result information 312, processing time information 313, and processing cost information 314, and the processing performance data 320 includes processing capacity information 321, operation performance information 322, and color management information 323.

As configured in this way, the processing time can be estimated from the contents of the job 230, and the job 230 can be assigned in accordance with the processing capabilities of the component apparatus. It is also possible to perform scheduling while considering the processing order of the job 230 to minimize the set change of the component apparatus, the periodic color management work to maintain color quality, and the downtime due to errors or failures of the component apparatus. As a result, the jobs 230 can be allocated efficiently. Thus, the jobs 230 can be output at low cost and high quality.

In addition, considering the processing capacity and setting status of the component apparatus, efficient processing of the jobs 230 can be performed. In addition, set changes such as changing the paper when printing, or the like, can be minimized. This makes it possible to make printing operations more efficient, reduce costs, and suppress deterioration in quality due to changes, or the like.

Further, it is possible to construct an autonomous automated system in which the management server determines the processing status of the component apparatus and performs processing.

In the industrial printing system X of the present embodiment, the job 230 includes the delivery date information 410, and the processing management unit 110 performs scheduling based on the conditions to be prioritized the delivery date information 410 or cost, and the threshold of the completion processing time of the job 230.

As configured in this way, it is possible to allocate a job 230 based on the deadline or cost set for the job 230 itself. Furthermore, by scheduling based on the completion threshold set for the job 230, it is possible to process the job 230 appropriately according to the user's intention.

### [Other Embodiments]

In the above-mentioned embodiment, an example described is of indicating cost or quality as the condition to be prioritized in the instruction information 420.

However, it is also possible to set both of these, and for example, to present the degree to which cost and quality are prioritized in a format such as a slide bar.

Also, it is possible to set whether cost or quality is prioritized, depending on the characteristics of the job 230 and the processing settings.

Furthermore, it is also possible to configure these settings in a format such as a macro language.

Further, it may be possible to set which of the following conditions to be prioritized: the condition that gives priority to the delivery date, the condition that gives priority to the operating rate, and the condition that gives priority to the number of processing jobs.

As configured in this way, it is possible to process the job 230 with the optimal cost, quality, delivery date, operating rate, and number of processing jobs in accordance with the user's or order's intentions.

Further, in the above-mentioned embodiment, it is described that the instruction information 420 is provided for each job 230.

However, for the unprocessed jobs 230, it may be configured so that the overall processing instructions are provided from the management terminal 6 as a user policy. In addition, the jobs 230 may be grouped and specific instructions may be provided.

As configured in this way, it is not necessary to provide instructions for each job 230, and usability can be improved.

In the above-mentioned embodiment, an example is described that a job 230 is generated by a management server 1 of a workflow system and the job 230 is allocated to a component apparatus connected with the management server 1.

However, it may be a system in which multiple management servers 1 are connected in a peer-to-peer manner. In this case, it is possible to allocate the jobs 230 to component apparatuses of management servers 1 at different locations.

Thus, the processing management unit 110 can transfer the job 230, which is processed by a component apparatus connected to a different management server 1 from its own management server 1, to the different management server 1.

Alternatively, a management server 1 that represents each job 230 may be set. In this way, the job 230 that has been sent to the management server 1 that represents the job 230 may be transferred from the representative management server 1 to a management server 1 at a different location.

As for such configuration, in the model 220, the component apparatuses of the management server 1 at a different location may be trained.

Alternatively, it may be configured so that jobs 230 are allocated between DFE of component apparatuses in a peer-to-peer manner without using management server 1. In this case, for example, a representative printing apparatus 2 may be set in place of the representative management server 1 for the job 230, and the representative printing apparatus 2 may perform the same processing as DFE. Furthermore, it may be possible to transfer the job 230 between component apparatuses.

As configured in this way, it is possible to allocate jobs 230 to component apparatuses that are located at different locations and are linked in a peer-to-peer manner. In other words, it is possible to optimally distribute and process jobs 230. As a result, it is possible to easily link existing company sites and other locations to improve the efficiency of execution of the job 230. In other words, it is possible to link multiple printing lines to improve the efficiency of the entire printing process.

Further, in the above-mentioned embodiment, an example described is one in which learning and the allocation of unprocessed jobs 230 are performed, sequentially.

However, it is also possible to handle the learning of model 220 and the allocation of jobs 230 by using the learned model 220 as separate processes. In this case, it is also possible to handle them by using separate management servers or servers dedicated to learning and allocation.

In the above-mentioned embodiment, the example described above is of outputting information on the optimal setting of the unprocessed job 230 and the allocation of scheduling in response to the user's instruction.

However, the processing management unit 110 may notify the management terminal 6 when the set time, set interval, or number of acquired jobs 230 reaches the set value of the condition, and obtain instructions from the user.

As configured in this way, it is possible to optimize the learning of the model 220 and the allocation of the jobs 230. Also, scheduling with any conditions set by the user can be started.

Therefore, in the user's environment, learning, configuration, scheduling output, and allocation of the job 230 at the appropriate time can be performed, and as a result, the jobs 230 can be processed efficiently and at low cost.

In the industrial printing system X of the present embodiment, the job 230 includes instruction information 420 indicating whether the delivery date or cost should be given priority, and the processing management unit 110 performs scheduling based on the instruction information 420 of the job 230.

As configured in this way, scheduling can be performed based on the instruction information 420 set in the job 230 itself. This allows efficient scheduling to be performed by combining the user's instruction and the instruction information 420 of the job 230 itself.

Further, in the above-described embodiment, an example has been described in which the model 220 is trained without distinguishing between rasterization process, printing process, and post-processing process of the job 230.

However, separate models 220 may be trained for rasterization process, printing process, and post-processing process.

As configured in this way, more accurate model 220 can be generated according to the type and number of component apparatuses for each process by fine-tuning, or the like.

In the above-mentioned embodiment, an example of executing jobs 230, as they are, is described.

However, it is also possible to change the job 230 itself in response to status notifications, completion notifications, error notifications, or the like, for each job 230.

In this case, it is also possible to change the job 230 in response to processing change information or alternative settings. In other words, when adjusting processing requests due to delays, it is possible to change the number of pages, color profiles to be used, or the like, in response to alternative settings, for example, as jobs 230 that can be processed. Furthermore, it is also possible to prepare a model 220 that takes these into account.

In the above-mentioned embodiment, the example described is one in which a job 230 is allocated to an available component apparatus of the schedule setting 200 one by one.

However, if there is not enough time to allocate the job to the available space, or if the number of pages or copies in the job is large, it is also possible to divide the job and allocate it to another available space. Furthermore, it is also possible to allocate the divided job to the available space of multiple component apparatuses one by one.

By configuring in this way, it is possible to perform flexible processing.

In addition, in the terminology used in this specification, the singular forms “a”, “an” and “the” also include the plural forms unless the context clearly indicates otherwise.

In addition, it goes without saying that the configuration and operation of the above-mentioned embodiments are examples, and that they can be changed and executed as appropriate within the scope of not deviating from the purpose of the present disclosure.

What is claimed is:

1. An industrial printing system that performs production printing having a component apparatus and a management server, comprising:
a database that stores characteristic data and processing result data of processed jobs and the processing performance data of the component apparatus;
a learning unit configured to learn a model that shows relationship between characteristics of the jobs and processing results and performance of the component apparatus based on the characteristic data, the processing result data, and the processing achievement data stored in the database; and
a processing management unit configured to output information on a job setting and a scheduling allocation for processing at optimal cost based on the model learned by the learning unit in accordance with instruction information that includes condition to be prioritized.

2. The industrial printing system according to claim 1, wherein
the database further stores operator work performance information,
the learning unit learns the model by adding the relationship between the operator and the work performance information, and
the processing management unit outputs information on operator allocation.

3. The industrial printing system according to claim 2, wherein
the database further stores order information indicating a busy period for orders and a trend in sudden orders, and
the learning unit also learns the relationship between schedule settings and the order information in the model.

4. The industrial printing system according to claim 3, wherein
the processing management unit also outputs the possibility of handling a sudden order by using the model.

5. The industrial printing system according to claim 1, wherein
the characteristic data of the job includes size information, content information, and post-processing information,
the processing result data includes output number information, processing result information, processing time information, and processing cost information, and
the processing performance data includes processing capacity information, operation performance information, and color management information.

6. A management server that manages jobs of component apparatuses in an industrial printing system that performs production printing, comprising:
a database that stores characteristic data and processing result data of processed jobs and the processing performance data of the component apparatus;
a learning unit configured to learn a model that shows relationship between characteristics of the jobs and processing results and performance of the component apparatus based on the characteristic data, the processing result data, and the processing achievement data stored in the database; and
a processing management unit configured to output information on a job setting and a scheduling allocation for processing at optimal cost based on the model learned by the learning unit in accordance with instruction information that includes condition to be prioritized.

7. The management server according to claim 6, wherein
the database further stores operator work performance information,
the learning unit learns the model by adding the relationship between the operator and the work performance information, and
the processing management unit outputs information on operator allocation.

8. The management server according to claim 7, wherein
the database further stores order information indicating a busy period for orders and a trend in sudden orders, and
the learning unit also learns the relationship between schedule settings and the order information in the model.

9. The management server according to claim 8, wherein
the processing management unit also outputs the possibility of handling a sudden order by using the model.

10. The management server according to claim 6, wherein
the characteristic data of the job includes size information, content information, and post-processing information,
the processing result data includes output number information, processing result information, processing time information, and processing cost information, and
the processing performance data includes processing capacity information, operation performance information, and color management information.

11. A processing management method executed by a management server that manages jobs of component apparatuses in an industrial printing system that performs production printing, comprising the steps of:
storing characteristic data and processing result data of processed jobs and the processing performance data of the component apparatus;
learning a model that shows relationship between characteristics of the jobs and processing results and performance of the component apparatus based on the characteristic data, the processing result data, and the processing achievement data that are stored; and
outputting information on a job setting and a scheduling allocation for processing at optimal cost based on the learned model in accordance with instruction information that includes condition to be prioritized.

12. The processing management method according to claim 11, further comprising the steps of:
storing operator work performance information,
learning the model by adding the relationship between the operator and the work performance information, and
outputting information on operator allocation.

13. The processing management method according to claim 12, further comprising the steps of:
storing order information indicating a busy period for orders and a trend in sudden orders, and
learning the relationship between schedule settings and the order information in the model.

14. The processing management method according to claim 13, further comprising the step of:
outputting the possibility of handling a sudden order by using the model.

15. The processing management method according to claim 11, wherein
the characteristic data of the job includes size information, content information, and post-processing information,
the processing result data includes output number information, processing result information, processing time information, and processing cost information, and
the processing performance data includes processing capacity information, operation performance information, and color management information.
